(19) United States
(12) Patent Application Publication
(10) Pub. No.: US 2014/0337793 A1
(43) Pub. Date: Nov. 13, 2014

(54) MOBILE DEVICE AND METHOD FOR OPERATING THE SAME

(71) Applicant: Samsung Display Co., Ltd., Yongin-city (KR)

(72) Inventors: Myung-Suk HAN, Yongin-City (KR); Chang-Yong JEONG, Yongin-City (KR)

(73) Assignee: Samsung Display Co., Ltd., Yongin-city (KR)

(21) Appl. No.: 14/264,861

(22) Filed: Apr. 29, 2014

(30) Foreign Application Priority Data
May 9, 2013 (KR) 10-2013-0052633

(51) Int. Cl. G06F 3/0481; G06F 3/0488; G06F 3/0484

(52) U.S. Cl. CPC G06F 3/0481; G06F 3/04842; G06F 3/04817; G06F 3/0488
USPC 715/798; 715/788; 715/800; 715/799

(57) ABSTRACT

There are provided a mobile device and a method for operating changing the shapes of a plurality of windows displayed in a display unit through a simple gesture. The mobile device includes a display unit, a touch screen panel and a processor. The display unit displays a plurality of windows. The touch screen panel senses a user's touch input applied to the display unit. The processor controls the display unit to change the shape of any one of the plurality of windows, when the touch input is applied to an area on which the window is displayed.

### CROSS-REFERENCE TO RELATED APPLICATION

This application claims priority to and the benefit of Korean Patent Application No. 10-2013-0052633, filed on May 9, 2013, which is hereby incorporated by reference for all purposes as if fully set forth herein.

### BACKGROUND

1. Field

Exemplary embodiments of the present invention relate to a mobile device.

2. Description of the Background

Recently, as the size of a display unit of a mobile device has increased and the resolution of the display unit has improved, it is demanded that a plurality of windows are required to be a display of a mobile device similar to a personal computer (PC).

### SUMMARY

Exemplary embodiments of the present invention provide a mobile device and a method for operating the mobile device, controlling shapes of a plurality of windows displayed in a display unit through a simple gesture.

Additional features of the invention will be set forth in the description which follows, and in part will be apparent from the description, or may be learned by practice of the invention.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

Exemplary embodiments of the present invention disclose a mobile device. The mobile device includes a display unit configured to display a plurality of windows. The mobile device also includes a touch screen panel configured to detect a touch input applied to the display unit. The mobile device includes a processor which is configured to change a shape of at least one window of the plurality of windows, in response to detection of the touch input applied to an area on which the at least one window is displayed.

Exemplary embodiments of the present invention disclose a method for operating a mobile device. The method includes displaying a plurality of windows. The method also includes detecting a touch input. The method includes changing a size of at least one window of the plurality of windows in response to the touch input being applied to an area on which the at least one window is displayed.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a view illustrating a mobile device according to exemplary embodiments of the present invention.

FIG. 2 is a block diagram illustrating in detail the mobile device shown in FIG. 1.

FIG. 3 is a view illustrating changes of the shapes of a plurality of windows displayed in a display unit of the mobile display shown in FIG. 1.

FIG. 4 is a flowchart of a process for changes of the shapes of a plurality of windows displayed in the display unit of the mobile display shown in FIG. 1.

FIG. 5 is a view illustrating changes the shapes of a plurality of windows displayed in the display unit of the mobile display shown in FIG. 1.

FIG. 6 is a flowchart of a process for illustrating changes of the shapes of a plurality of windows displayed in the display unit of the mobile display shown in FIG. 1.

FIG. 7 is a view illustrating changes the shapes of the plurality of windows displayed in the display unit of the mobile display shown in FIG. 1.

FIG. 8 is a flowchart of a process for illustrating changes of the shapes of a plurality of windows displayed in the display unit.

FIG. 9 is a view illustrating changes of the shapes of the plurality of windows displayed in the display unit.

FIG. 10 is a diagram of hardware upon which various embodiments of the invention can be implemented

### DETAILED DESCRIPTION OF THE ILLUSTRATED EMBODIMENTS

A display of a mobile device and a method for operating the mobile device, controlling shapes of a plurality of windows displayed in a display unit through a simple gesture are disclosed. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

Hereinafter, exemplary embodiments according to the present invention will be described in detail with reference to the accompanying drawings.

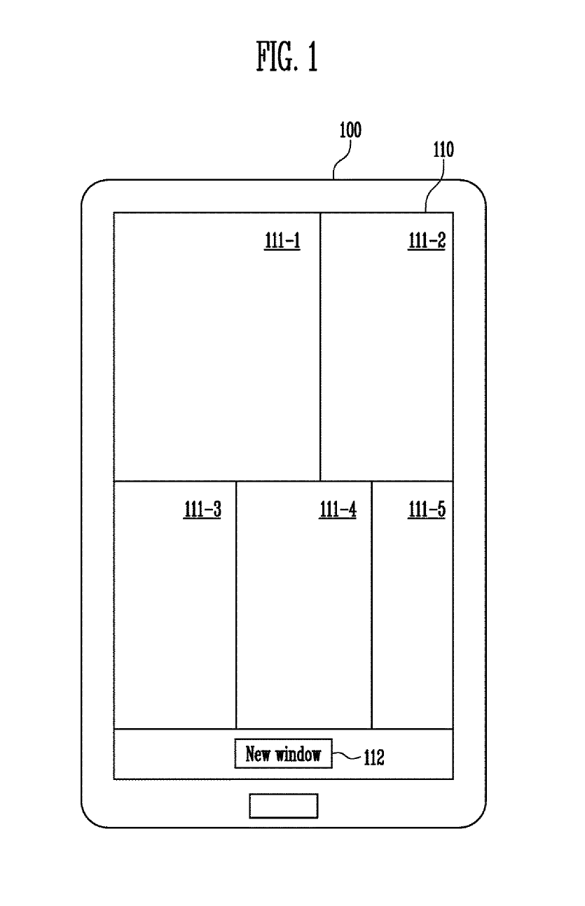

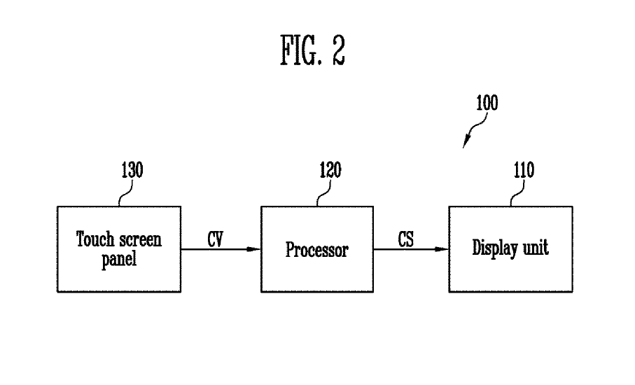

FIG. 1 is a view illustrating a mobile device according to exemplary embodiments of the present invention. FIG. 2 is a block diagram illustrating in detail the mobile device shown in FIG. 1.

Referring to FIGS. 1 and 2, the mobile device 100 may include a display unit 110, a processor 120 and a touch screen panel 130.

Although it has been illustrated in FIG. 2 that the display unit 110 and the touch screen panel 130 are different devices for convenience of illustration, the technical scope of the present invention is not limited thereto. For example, the display unit 110 may perform functions of the touch screen panel 130. In other words, the touch screen panel 130 may be a separate panel disposed on the display unit 110, or the touch screen panel 130 may be integrally formed with the display unit 110. In some cases, the touch screen panel 130 may include touch screen panels on both sides of the display unit 110.

The display unit 110 displays a plurality of windows 111-1 to 111-5 as a user desires. The user may control the mobile device 100 to additionally display a new window by touching a touch input of an icon 112 for adding a window, which is displayed on the display unit 110. The plurality of windows 111-1 to 111-5 may display an execution screen of the same application or execution screens of different applications.

The processor 120 outputs, to the display unit 110, a control signal CS to change or to control the shapes of the plurality of windows 111-1 to 111-5 displayed in the display unit 110, in response to a coordinate value CV output from the touch screen panel 130.

The processor 120 selects a kind of change in the shapes of the plurality of windows 111-1 to 111-5, e.g., enlargement/reduction, termination or movement, according to a number of touch points of a touch input, duration time of maintaining of the touch points, and drag directions of the touch points.

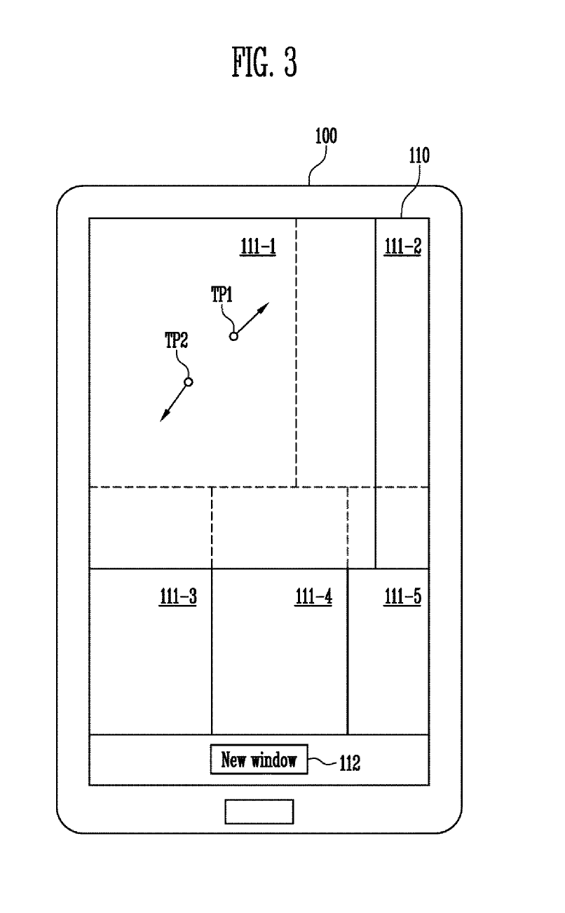

The process of changing the shapes of the plurality of windows 111-1 to 111-5 displayed in the display unit 110 will be described in detail with reference to FIGS. 3 to 9.

The touch screen panel 130 senses a user's touch input applied to the display unit 110. The touch screen panel 130 outputs a coordinate value CV of a touch point of the touch input to the processor 120.

The processor 120 outputs, to the display unit 120, a control signal CS to change the shape of a window corresponding to the coordinate value CV, i.e., the window to which the touch input is applied, in response to the coordinate value output from the touch screen panel 130.

The display unit 130 changes the shape of the window to which the touch input is applied, in response to the control signal output from the processor 120. In some cases, the shapes of the windows to which the touch input is not applied among the plurality of windows 111-1 to 111-5 may be changed together with the shape of the window to which the touch input is applied. In other cases, the shapes of the windows to which the touch input is not applied among the plurality of windows 111-1 to 111-5 may not be changed together with the shape of the window to which the touch input is applied.

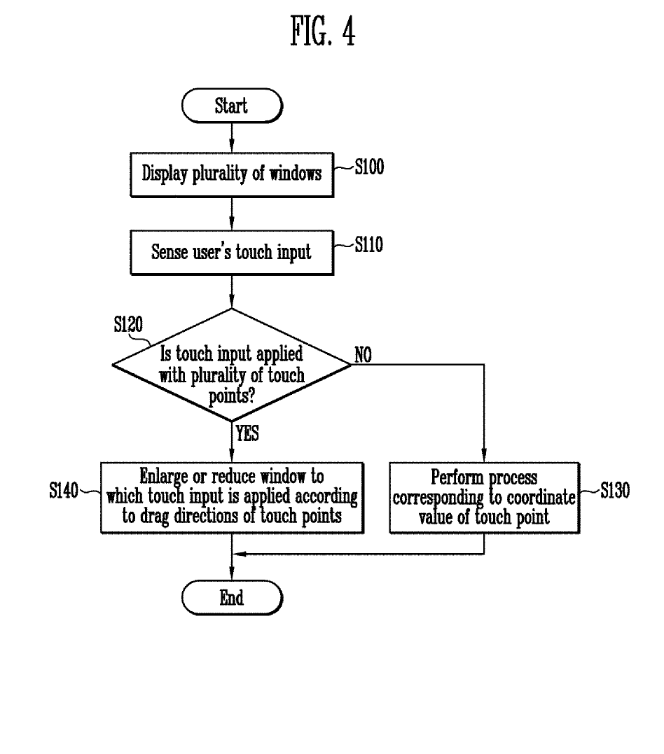

FIG. 3 is a view illustrating changes of the shapes of the plurality of windows displayed in the display unit of the mobile display shown in FIG. 1. FIG. 4 is a flowchart of a process for changes of the shapes of a plurality of windows displayed in the display unit of the mobile display shown in FIG. 1.

Referring to FIGS. 3 and 4, the display unit 110 displays the plurality of windows 111-1 to 111-5 (S100), and the touch screen panel 130 senses a user's touch input to the display unit 110 (S110). The processor 120 determines whether the touch input is applied with a plurality of touch points (S120).

In a case where it is determined that the touch input has been applied with one touch point, the processor 120 performs a process corresponding to a coordinate value of the touch point (S130). On the contrary, in a case where it is determined that the touch input has been applied with a plurality of touch points, the processor 120 enlarges or reduces the window to which the touch input is applied according to drag directions of the touch points (S140). Here, the amount of enlargement or reduction in size may be determined according to the length of the drags.

For example, it is assumed that, as shown in FIG. 3, a user's touch input is applied with a plurality of touch points TP1 and TP2 to the area on which a first window 111-1 among the plurality of windows 111-1 to 111-5 is displayed.

The touch screen panel 130 outputs coordinate values CV of the plurality of touch points TP1 and TP2 to the processor 120. The processor 120 outputs, to the display unit 110, a size change control signal CS for changing the size of the first window 111-1 according to the drag directions (directions of arrows) of the plurality of touch points TP1 and TP2, based on the coordinate values CV output from the touch screen panel 130.

The display unit 110 enlarges or reduces the first window 111-1 in response to the size change control signal output from the processor 120.

In this case, the display unit 110 may also change the sizes of the other windows 111-2 to 111-5 among the plurality of windows 111-1 to 111-5, corresponding to the enlargement or reduction of the first window 111-1. For example, the display unit 110 may change the sizes of the other windows 111-2 to 111-5 while maintaining size ratios between the other windows 111-2 to 111-5. Thus, in response to the input shown in FIG. 3, initial sizes of the windows 111-1 to 111-5, shown by the dotted lines, change to the sizes shown by the full lines. Similarly, in response to a reverse of the input shown in FIG. 3 (i.e., touch points TP1 and TP2 have wider, initial separation and are dragged towards each other), where initial sizes of the windows 111-1 to 111-5 are shown by the full lines, the sizes of the windows 111-1 to 111-5 may change to the sizes shown by the dotted lines.

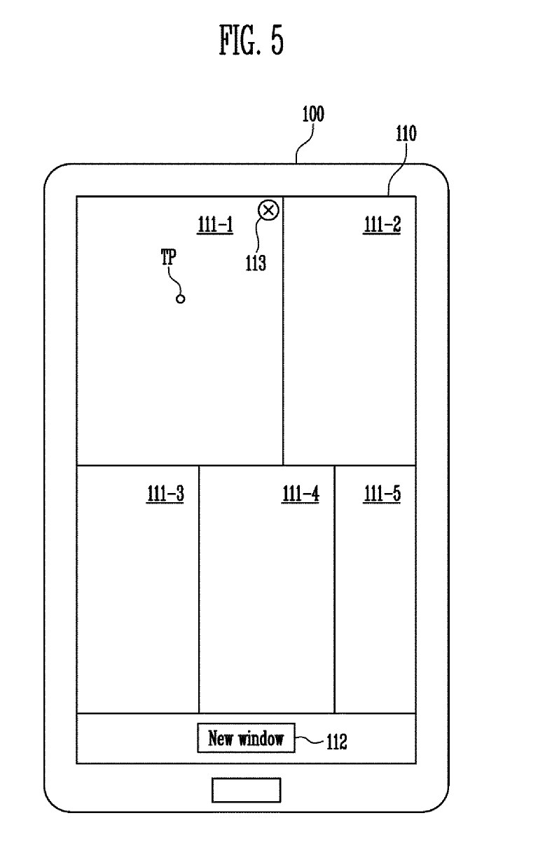

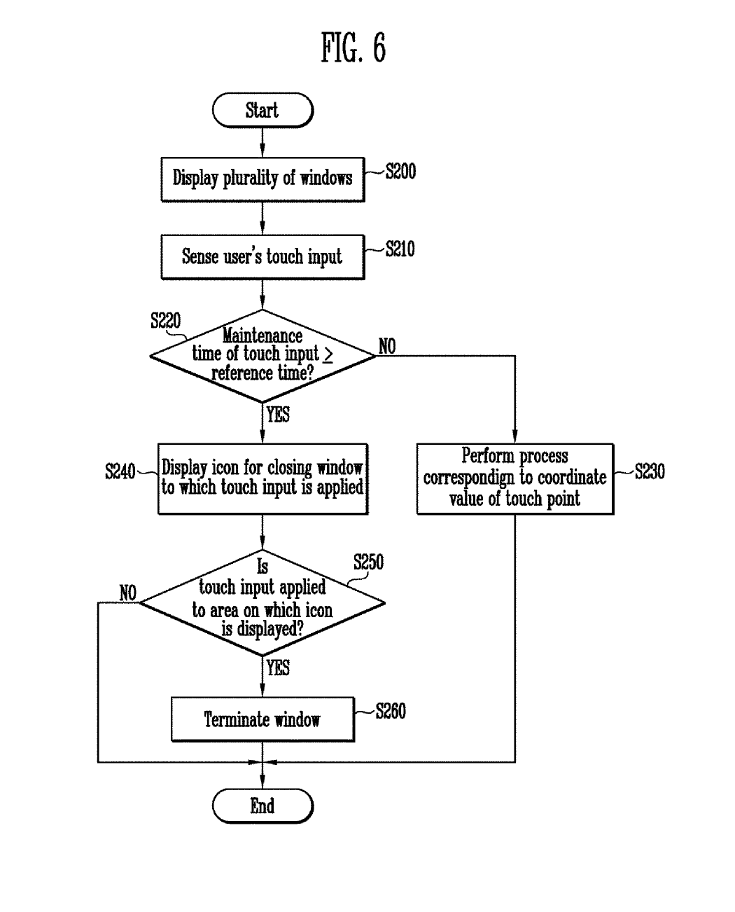

FIG. 5 is a view illustrating changes the shapes of a plurality of windows displayed in the display unit of the mobile display shown in FIG. 1. FIG. 6 is a flowchart of a process for illustrating changes of the shapes of a plurality of windows displayed in the display unit of the mobile display shown in FIG. 1.

Referring to FIGS. 5 and 6, the display unit 110 displays the plurality of windows 111-1 to 111-5 (S200), and the touch screen panel 130 senses a user's touch input to the display unit 110 (S210). The processor 120 determines whether the touch input is maintained for a threshold amount of time (S220).

In a case where it is determined that the touch input is maintained less than the threshold amount of time, the processor 120 performs a process corresponding to the coordinate value of a touch point (S230). On the contrary, in a case where the touch input is maintained the threshold amount of time, the processor 120 displays an icon 113 for closing the window (S240). In an alternative embodiment, instead of displaying icon 113, a pop-up window or other notification may be displayed that states, for example, “Close Window?” and includes “Yes” and “No” response alternatives. Further touch input received on the “Yes” and “No” alternatives causes the processor 120 to control the corresponding window accordingly.

Subsequently, if a user's touch input is applied to the area on which the icon 113 is displayed (YES branch of S250), the processor 120 terminates the window (S260).

For example, it is assumed that, as shown in FIG. 5, the duration time of a touch input applied to the area on which the first window 111-1 among the plurality of windows 111-1 to 111-5 meets the threshold amount of time.

The touch screen panel 130 outputs a coordinate value CV of a touch point TP to the processor 120. The processor 120 outputs, to the display unit 110, an icon display control signal CS for displaying an icon 113 for closing the first window 111-1, in response to the coordinate value CV output from the touch screen panel 130. The display unit 110 displays the icon 113 for closing the first window 111-1 on a partial area in the area on which the first window 111-1 is displayed, in response to the icon display control signal CS.

Subsequently, if a user's touch input is applied to the area on which the icon is displayed, the processor 120 outputs a termination control signal CS for terminating the first window 111-1 to the display unit 110, and the display unit 110 terminates the first window 111-1 in response to the termination control signal CS.

In this case, the display unit 110 may also change the sizes of the other windows 111-2 to 111-5 among the plurality of windows 111-1 to 111-5, corresponding to the termination of the first window 111-1. For example, the display unit 110 may change the sizes of the other windows 111-2 to 111-5 while maintaining size ratios between the other windows 111-2 to 111-5.

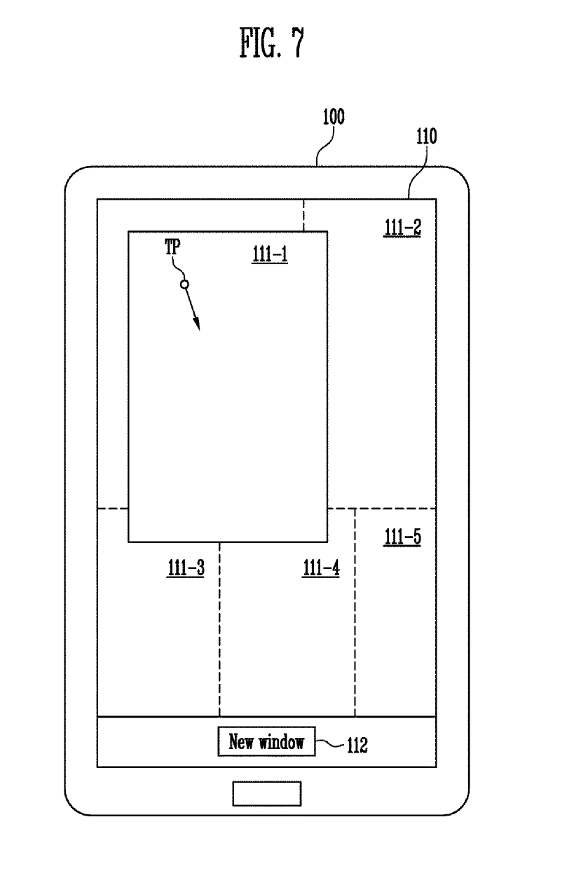

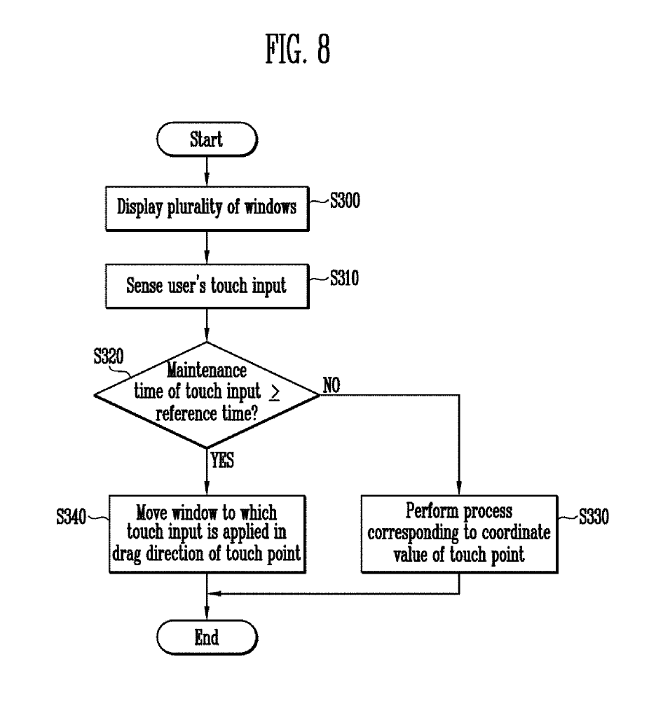

FIG. 7 is a view illustrating changes the shapes of the plurality of windows displayed in the display unit of the mobile display shown in FIG. 1. FIG. 8 is a flowchart of a process for illustrating changes of the shapes of a plurality of windows displayed in the display unit.

Referring to FIGS. 7 and 8, the display unit 110 displays the plurality of windows 111-1 to 111-5 (S300), and the touch screen panel 130 senses a user's touch input to the display unit 110 (S310). The processor 120 determines whether the touch input is maintained for a threshold amount of time (S320).

In a case where it is determined that the touch input is less than the threshold amount of time, the processor 120 performs a process corresponding to the coordinate value of a touch point (S330). On the contrary, in a case where the touch input is the threshold amount of time, the processor 120 moves the window to which the touch input is applied in the drag direction of the touch point (S340).

For example, it is assumed that, as shown in FIG. 7, the time of a touch input applied to the area on which the first window 111-1 among the plurality of windows 111-1 to 111-5 is the threshold amount of time.

The touch screen panel 130 outputs a coordinate value CV of a touch point TP to the processor 120. The processor 120 outputs, to the display unit 110, a movement control signal CS for moving the first window 111-1 in a drag direction (direction of arrow) of the touch point TP, in response to the coordinate value output from the touch screen panel 130. The display unit 110 moves the first window 111-1 in the drag direction, in response to the movement control signal CS.

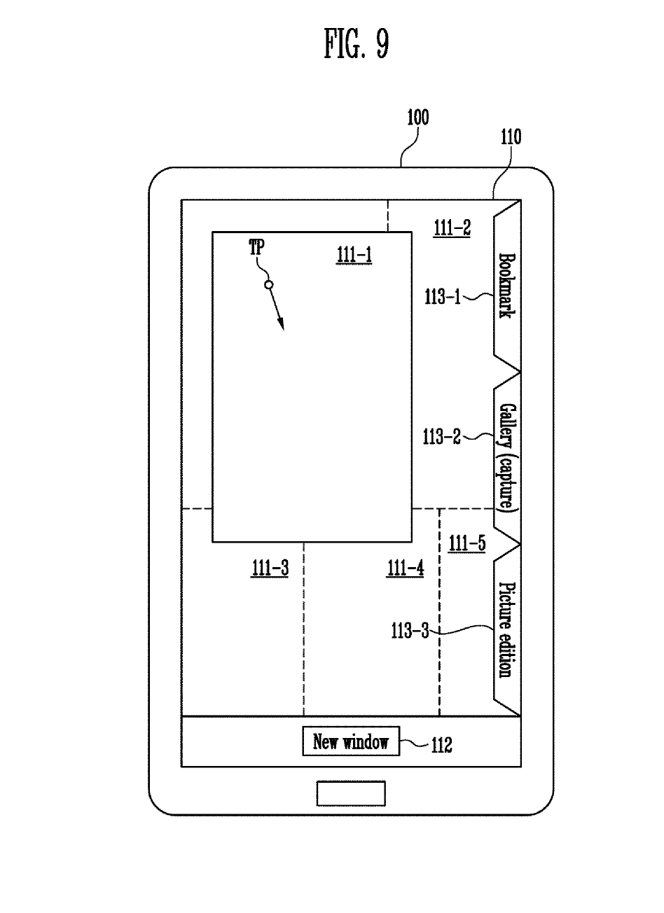

FIG. 9 is a view illustrating changes of the shapes of the plurality of windows displayed in the display unit.

Referring to FIG. 9, in a case where the duration time of a touch input applied to the area on which the first window 111-1 is displayed among the plurality of windows 111-1 to 111-5 is the threshold amount of time, the processor 120 moves the first window 111-1 in a drag direction (direction of arrow) of the touch point TP and simultaneously displays a partial area of the display unit 110, e.g., connection icons 113-1 to 113-3 on a right area of the display unit 110 as shown in FIG. 9.

Each of the connection icons 113-1 to 113-3 is an icon for connecting the window selected by the user, i.e., the first window 111-1 to which the touch input is applied, to another application. That is, the user moves the first window 111-1 to the area on which any one of the connection icons 113-1 to 113-3 is displayed, thereby executing another application related to the first window 111-1. Although FIG. 9 shows the first window 111-1 having the same size before and during its movement, in other exemplary embodiments, the first window 111-1 may be reduced in size (e.g., to have a length equal to a length of a connection icon) before or during any point in its movement so that a user may more easily see which connection icon the first window 111-1 is being dragged to.

As an example, if the user moves the first window 111-1 to a first connection icon 113-1, the processor 120 adds the address of the Internet page of the first window 111-1 to a bookmark.

As another example, if the user moves the first window 111-1 to a second connection icon 113-2, the processor 120 captures and stores a screen displayed on the first window 111-1.

As still another example, if the user moves the first window 111-1 to a third connection icon 113-3, the processor 120 executes an application for editing the screen displayed on the first window 111-1.

As noted above, the user may move the first window 111-1 to the area on which any one of the connection icons 113-1 to 113-3 is displayed, thereby executing another application related to the first window 111-1. Upon movement of the first window 111-1 and execution of the selected application, the display unit 110 may then display windows 111-1 to 111-5 like they were displayed prior to the touch and drag. For example, windows 111-1 to 111-5 may be displayed as shown in FIG. 1 after execution of the selected application.

To sum up, only one window is displayed in most mobile devices. Although a plurality of windows may be displayed in other devices, the sizes of the displayed windows may be fixed, or any one of the displayed windows is activated, reducing user's convenience.

In the mobile device and the method for operating the same according to exemplary embodiments, shapes of a plurality of windows displayed in the display unit are changed through a simple gesture, thereby improving user's convenience.

According to exemplary embodiments of the present invention, there is provided a mobile device that includes a display unit configured to display a plurality of windows. The mobile device includes a touch screen panel configured to sense a user's touch input applied to the display unit and the mobile device includes a processor which is configured to control the display unit to change the shape of any one of the plurality of windows, when the touch input is applied to an area of the display unit.

When the touch input is applied with a plurality of touch points, and the applied touch points are dragged, the processor may output, to the display unit, a size change control signal to enlarge or to reduce the window according to drag directions of the touch points.

The display unit may change the size of each of the plurality of windows, in response to the size change control signal.

When the touch input is applied for a threshold amount of time, the processor may output, to the display unit, an icon display control signal for displaying an icon for closing the window.

When the touch input is applied to an area on which the icon is displayed while the icon is being displayed, the processor may output, to the display unit, a window termination control signal for closing the window.

The display unit may close the window and change the sizes of the other windows, in response to the window termination control signal.

When a touch point of the touch input is dragged after the touch input is applied for a threshold amount of time, the processor may output, to the display unit, a movement control signal for moving the window in a drag direction of the touch point.

The display unit may display the one or more windows as translucent windows, while moving the window in the drag direction.

According to exemplary embodiments of the present invention, there is provided a method for operating a mobile device. The method includes displaying a plurality of windows. The method includes detecting a user's touch input and the method includes changing a size of at least one window of the plurality of windows in response to the touch input being applied to an area on which the at least one window is displayed.

The changing of the shape of the window may include enlarging or reducing the window according to drag directions of a plurality of touch points, when the touch input is applied with the plurality of touch points; and performing a process corresponding to a coordinate value of any one of the plurality of touch points, when the touch input is applied with the touch point.

The changing of the shape of the window may include displaying an icon for closing any one of the plurality of windows, when the touch input is applied for more than a threshold amount of time.

The changing of the shape of the one window may further include closing the window, when the touch input is applied to an area on which the icon is displayed while the icon is being displayed.

The changing of the shape of the window may include displaying the other windows as translucent and moving the window in a drag direction according to the touch point of the touch input, when the touch point of the touch input is dragged after the touch input is applied for a threshold amount of time.

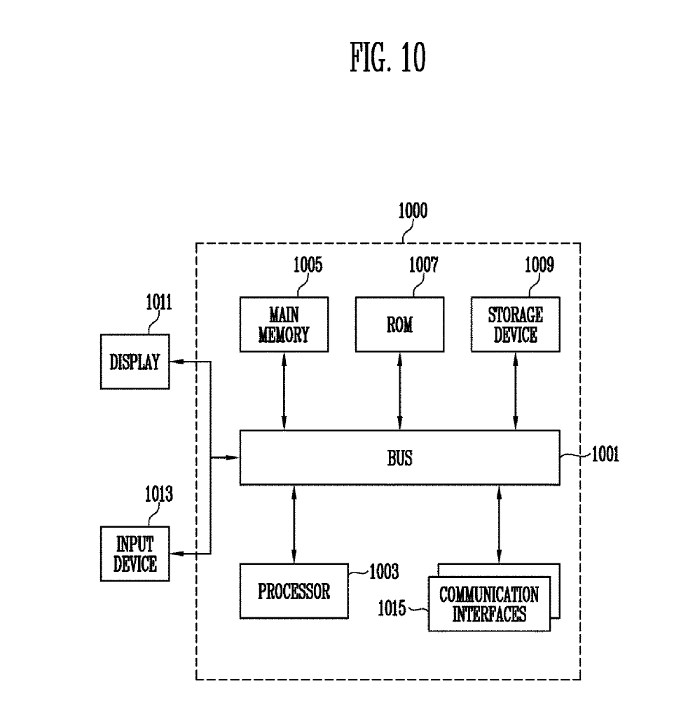

FIG. 10 illustrates exemplary hardware upon which various embodiments of the invention can be implemented. A computing system 1000 includes a bus 1001 or other communication mechanism for communicating information and a processor 1003 coupled to the bus 1001 for processing information. The computing system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computing system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computing system 1000 may be coupled via the bus 1001 to a display 1011, such as a liquid crystal display, or active matrix display, for displaying information to a user. An input device 1013, such as a keyboard including alphanumeric and other keys, may be coupled to the bus 1001 for communicating information and command selections to the processor 1003. The input device 1013 can include a cursor control, such as a mouse, a trackball, or cursor direction keys, for communicating direction information and command selections to the processor 1003 and for controlling cursor movement on the display 1011.

According to various embodiments of the invention, the processes described herein can be provided by the computing system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1000 also includes at least one communication interface 1015 coupled to bus 1001. The communication interface 1015 provides a two-way data communication coupling to a network link (not shown). The communication interface 1015 sends and receives electrical, electromagnetic, or optical signals that carry digital data streams representing various types of information. Further, the communication interface 1015 can include peripheral interface devices, such as a Universal Serial Bus (USB) interface, a PCMCIA (Personal Computer Memory Card International Association) interface, etc.

The processor 1003 may execute the transmitted code while being received and/or store the code in the storage device 1009, or other non-volatile storage for later execution. In this manner, the computing system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a mobile device, personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile device, comprising:
a display unit configured to display a plurality of windows;
a touch screen panel configured to detect a touch input applied to the display unit; and
a processor configured to control the display unit to change a shape of at least one window of the plurality of windows, in response to detection of the touch input applied to an area on which the at least one window is displayed.

2. The mobile device of claim 1, wherein, in response to detection of the touch input applied associated with a plurality of dragged touch points, the processor is configured to output, to the display unit, a size change control signal to enlarge or reduce a size of at least one window according to drag directions of the touch points.

3. The mobile device of claim 2, wherein the display unit is configured to change the size of each of the plurality of windows, in response to the size change control signal.

4. The mobile device of claim 1, wherein, in response to detection of a touch input applied for a threshold amount of time, the processor is configured to output, to the display unit, an icon display control signal to cause display of an icon for closing a window on which the touch point is detected.

5. The mobile device of claim 4, wherein, in response to detection of a touch input applied to an area on which the icon is displayed, the processor is configured to output, to the display unit, a window termination control signal to close the window.

6. The mobile device of claim 5, wherein the display unit is configured to close the window and to change the sizes of the other windows, in response to the window termination control signal.

7. The mobile device of claim 1, wherein, in response to detection of a touch point on a first window being maintained for a threshold amount of time followed by a dragging of the touch point, the processor is configured to output, to the display unit, a movement control signal to move the first window in a drag direction of the touch point.

8. The mobile device of claim 7, wherein the display unit is configured to display one or more windows to be translucent, in response to receipt of the movement control signal, and to move the window in the drag direction of the window to be displayed.

9. The mobile device of claim 7, wherein the processor is further configured to output, to the display unit, a signal to reduce a size of the first window.

10. A method for operating a mobile device, the method comprising:
displaying a plurality of windows;
detecting a touch input; and
changing a shape of at least one window of the plurality of windows in response to the touch input being applied to an area on which the at least one window is displayed.

11. The method of claim 10, wherein the changing the shape of the at least one window comprises:
enlarging or reducing the at least one window according to drag directions of a plurality of touch points.

12. The method of claim 10, further comprising:
displaying an icon for closing a window in response to detection of a touch input maintained for a threshold amount of time on the window.

13. The method of claim 12, further comprising:
closing the window in response to detection of a touch input applied to an area on which the icon is displayed.

14. The method of claim 10, further comprising:
moving, in response to detection of a touch point on a first window being maintained for a threshold amount of time followed by a dragging of the touch point, the first window in a drag direction of the touch point.

15. The method of claim 14, further comprising:
displaying one or more windows as translucent windows while moving the first window.

16. The method of claim 14, further comprising:
reducing a size of the first window upon or after detection of the touch point on the first window being maintained for the threshold amount of time.
